(19) United States
(12) Patent Application Publication
(10) Pub. No.: US 2009/0037660 A1
(43) Pub. Date: Feb. 5, 2009

(54) Time-based cache control

(75) Inventor: Mark Fairhurst, Manchester (GB)

Correspondence Address: Gerald W. Maliszewski, P.O. Box 270829, San Diego, CA, 92198-2829, US

(73) Assignee: Applied Micro Circuits Corporation, San Diego, CA (US)

(21) Appl. No.: 11/888,950

(22) Filed: Aug. 4, 2007

(51) Int. Cl. G06F 12/00

(52) U.S. Cl. 711/129

(57) ABSTRACT

A time-based system and method are provided for controlling the management of cache memory. The method accepts a segment of data, and assigns a cache lock-time with a time duration to the segment. If a cache line is available, the segment is stored (in cache). The method protects the segment stored in the cache line from replacement until the expiration of the lock-time. Upon the expiration of the lock-time, the cache line is automatically made available for replacement. An available cache line is located by determining that the cache line is empty, or by determining that the cache line is available for a replacement segment. In one aspect, the cache lock-time is assigned to the segment by accessing a list with a plurality of lock-times having a corresponding plurality of time duration, and selecting from the list. In another aspect, the lock-time durations are configurable by the user.

### BACKGROUND OF THE INVENTION

1. Field of the Invention

This invention generally relates to digital memory devices and, more particularly, to a system and method for using a time-based process to control the replacement of data in a cache memory.

2. Description of the Related Art

Small CPU-related memories can be made to perform faster than larger main memories. Most CPUs use one or more caches, and modern general-purpose CPUs inside personal computers may have as many as half a dozen, each specialized to a different part of the problem of executing programs.

A cache is a temporary collection of digital data duplicating original values stored elsewhere. Typically, the original data is expensive to fetch, due to a slow memory access time, or to compute, relative to the cost of reading the cache. Thus, cache is a temporary storage area where frequently accessed data can be stored for rapid access. Once the data is stored in the cache, the cached copy can be quickly accessed, rather than re-fetching or recomputing the original data, so that the average access time is lower.

Caches have proven to be extremely effective in many areas of computing because access patterns in typical computer applications have locality of reference. A CPU and hard drive frequently use a cache, as do web browsers and web servers.

FIG. 1 is a diagram of a cache memory associated with a CPU (prior art). A cache is made up of a pool of entries. Each entry has a datum or segment of data which is a copy of a segment in the backing store. Each entry also has a tag, which specifies the identity of the segment in the backing store of which the entry is a copy.

When the cache client, such as a CPU, web browser, operating system wishes to access a data segment in the backing store, it first checks the cache. If an entry can be found with a tag matching that of the desired segment, the segment in cache is accessed instead. This situation is known as a cache hit. So for example, a web browser program might check its local cache on disk to see if it has a local copy of the contents of a web page at a particular URL. In this example, the URL is the tag, and the contents of the web page are the segment. Alternately, when the cache is consulted and found not to contain a segment with the desired tag, a cache miss results. The segment fetched from the backing store during miss handling is usually inserted into the cache, ready for the next access.

If the cache has limited storage, it may have to eject some entries to make room for other entries. The heuristic used to select the entry to eject is known as the replacement policy. One popular replacement policy, least recently used (LRU), replaces the least recently used entry. More efficient caches compute use frequency against the size of the stored contents, as well as the latencies and throughputs for both the cache and the backing store. While this system works well for larger amounts of data, long latencies, and slow throughputs, such as experienced with a hard drive and the Internet, it's not efficient to use these algorithms for cached main memory (RAM).

When a data segment is written into cache, it is typically, at some point, written to the backing store as well. The timing of this write is controlled by what is known as the write policy. In a write-through cache, every write to the cache causes a write to the backing store. Alternatively, in a write-back cache, writes are not immediately mirrored to the store. Instead, the cache tracks which of its locations (cache lines) have been written over. The segments in these “dirty” cache lines locations are written back to the backing store when those data segments are replaced with a new segment. For this reason, a miss in a write-back cache will often require two memory accesses to service: one to retrieve the needed segment, and one to write replaced data from the cache to the store.

Data write-back may be triggered by a client makes changes to a segment in the cache, and explicitly notifies the cache to write back the modified segment into the backup store. No-write allocation is a cache policy where only processor reads are cached, thus avoiding the need for write-back or write-through when the old value of the data segment is absent from the cache prior to the write.

The data in the backing store may be changed by entities other than the cache, in which case the copy in the cache may become out-of-date or stale. Alternatively, when the client updates the data in the cache, copies of that data in other caches will become stale. Communication protocols between the cache managers which keep the data consistent are known as coherency protocols.

CPU caches are generally managed entirely by hardware. Other caches are managed by a variety of software. The cache of disk sectors in main memory is usually managed by the operating system kernel or file system. The BIND DNS daemon caches a mapping of domain names to IP addresses, as does a resolver library.

Write-through operations are common when operating over unreliable networks (like an Ethernet LAN), because of the enormous complexity of the coherency protocol required between multiple write-back caches when communication is unreliable. For instance, web page caches and client-side network file system caches (like those in NFS or SMB) are typically read-only or write-through, specifically to keep the network protocol simple and reliable.

A cache of recently visited web pages can be managed by a web browser. Some browsers are configured to use an external proxy web cache, a server program through which all web requests are routed so that it can cache frequently accessed pages for everyone in an organization. Many internet service providers use proxy caches to save bandwidth on frequently-accessed web pages.

Search engines also frequently make web pages they have indexed available from their cache. For example, a “Cached” link next to each search result may be provided. This is useful when web pages are temporarily inaccessible from a web server.

Another type of caching is storing computed results that will likely be needed again. An example of this type of caching is ccache, a program that caches the output of the compilation to speed up the second-time compilation.

In contrast to cache, a buffer is a temporary storage location where a large block of data is assembled or disassembled. This large block of data may be necessary for interacting with a storage device that requires large blocks of data, or when data must be delivered in a different order than that in which it is produced, or when the delivery of small blocks is inefficient. The benefit is present even if the buffered data are written to the buffer only once and read from the buffer only once. A cache, on the other hand, is useful in situations where data is read from the cache more often than they are written there. The purpose of cache is to reduce accesses to the underlying storage.

Cache replacement algorithms are optimizing instructions that a computer program or a hardware-maintained structure can follow to manage a cache of information. The LRU algorithm discards the least recently used items first. This algorithm requires keeping track of what was used when, which is expensive if one wants to make sure the algorithm always discards the least recently used item. The Most Recently Used (MRU) algorithm discards the most recently used items first. This caching mechanism is used when access is unpredictable, and determining the least most recently used section of the cache system is a complex operation. Database memory caches often use the MRU algorithm.

A Pseudo-LRU (PLRU) algorithm is used for caches with large associativity (generally >4 ways), when the implementation cost of LRU starts to become prohibitive. If a probabilistic scheme that almost always discards one of the least recently used items is sufficient, the Pseudo-LRU algorithm can be used which only needs one bit per cache item to work. The Least Frequently Used (LFU) algorithm counts how often an item is needed. Those segments that are used least often are discarded first.

The most efficient caching algorithm would be one that discards the information that will not be needed for the longest time. Since it is impossible to predict how far in the future information will be needed, this algorithm is not conventionally implemented in hardware. The Adaptive Replacement Cache (ARC) algorithm improves on LRU by constantly balancing between recency and frequency.

As noted above, caching structures are often used in computer systems dealing with persistent data. The processor loads the data into the cache at the start of, and during processing. Access latencies are improved during processing as the cache provides a store to hold the data structures closer to the processor than the main memory. The conventional cache line replacement algorithms select segments based upon the order in which elements were loaded or accessed within the cache. However, these replacement algorithms are not necessarily efficient for transient data. Conventionally, transient data is either located within the main (off chip) data store and/or within on-chip buffers or queues. The management of these on-chip resources can be complicated with the sizing of on-chip storage. It is difficult to determine and map the different addresses required between the on-chip and off-chip stores. To combat the inefficiencies in the cache replacement of transient data, cache “stashing” techniques are widely deployed, which allow the locking of lines within the cache. Cache lines are locked until they are explicitly unlocked by an external processor, usually upon completion of data processing.

However, the source (e.g., a line interface) may not be a processor and, hence, have no visibility into the processor congestion (work queue buildup). Therefore, the source may have no information upon which to decide whether or not to request a lock. Further, the lock decision is committed at the time of request, which may not coincide with the congestion peak on the processor. The locking of cache lines in times of processor congestion can result in the number of locked lines increasing to the point where the overall cache efficiency degrades.

It would be advantageous if time-based replacement algorithm could be implemented to handle transient data segments.

### SUMMARY OF THE INVENTION

A time-based cache control mechanism is provided for the processing of transient or time sensitive data, for example, in network or digital signal processing applications. The cache control mechanism optimizes performance (cache and backing store efficiency), simplifies cache management, and protects against mismanagement. These benefits are achieved through combining a minimum guaranteed time in cache, if cache store is obtained, and replacement mechanisms to backing store, once the minimum guaranteed time elapses. New data can be marked cacheable without the knowledge of processor congestion. During periods of congestion, the time-based caching mechanism prevents excessive thrashing of the cache store as well as autonomously making “old” cache lines available for replacement, effectively removing the lock for valid lines which have exceeded their expected “time to live” period.

Accordingly, a time-based method is provided for controlling the management of cache memory. The method accepts a segment of data, and assigns a cache lock-time with a time duration to the segment. If a cache line is available, the segment is stored (in cache). The method protects the segment stored in the cache line from replacement until the expiration of the lock-time. Upon the expiration of the lock-time, the cache line is automatically made available for a replacement segment.

An available cache line is located either by determining that the cache line is empty, or by determining that the cache line is available for a replacement segment. In one aspect, the cache lock-time is assigned to the segment by accessing a list with a plurality of lock-times having a corresponding plurality of time duration, and selecting a lock-time from the list. In another aspect, the lock-time durations are configurable by the user.

Additional details of the above-described method and time-based cache memory management system are provided below.

### BRIEF DESCRIPTION OF THE DRAWINGS

FIG. 1 is a diagram of a cache memory associated with a CPU (prior art).

FIG. 2 is a schematic block diagram of a time-based cache memory management system.

FIG. 3 is a flowchart illustrating a time-based method for controlling the management of cache memory.

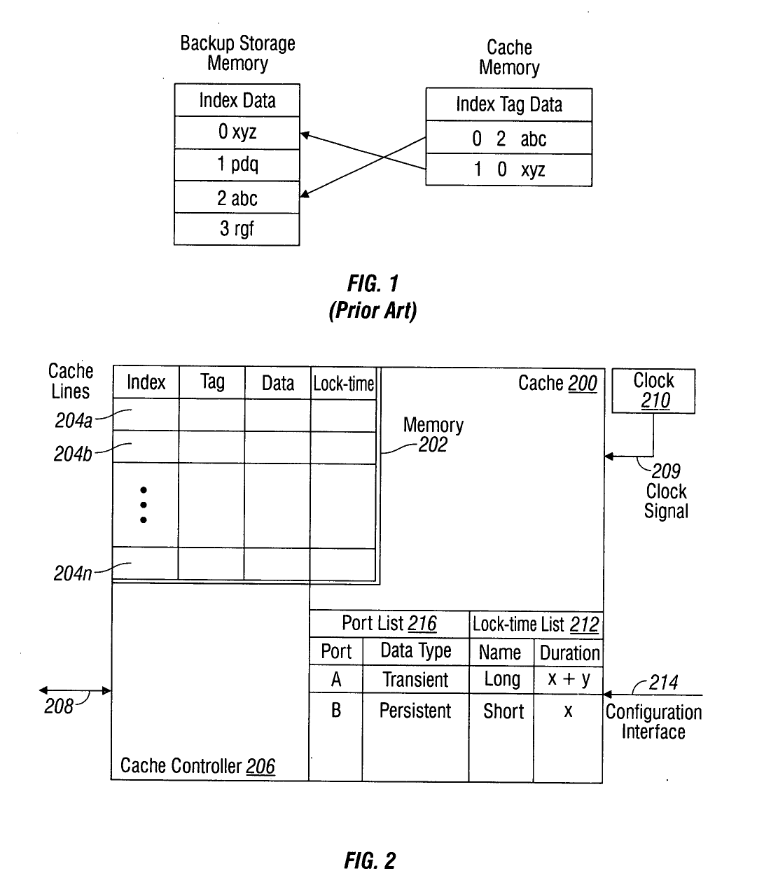

### DETAILED DESCRIPTION

Various embodiments are now described with reference to the drawings. In the following description, for purposes of explanation, numerous specific details are set forth in order to provide a thorough understanding of one or more aspects. It may be evident, however, that such embodiment(s) may be practiced without these specific details. In other instances, well-known structures and devices are shown in block diagram form in order to facilitate describing these embodiments.

As used in this application, the terms “processor”, “processing device”, “component,” “module,” “system,” and the like are intended to refer to a computer-related entity, either hardware, firmware, a combination of hardware and software, software, or software in execution. For example, a component may be, but is not limited to being, a process running on a processor, generation, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

Various embodiments will be presented in terms of systems that may include a number of components, modules, and the like. It is to be understood and appreciated that the various systems may include additional components, modules, etc. and/or may not include all of the components, modules etc. discussed in connection with the figures. A combination of these approaches may also be used.

The various illustrative logical blocks, modules, and circuits that have been described may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor. The processor and the storage medium may reside in an ASIC. The ASIC may reside in the node, or elsewhere. In the alternative, the processor and the storage medium may reside as discrete components in the node, or elsewhere in an access network.

FIG. 2 is a schematic block diagram of a time-based cache memory management system. The system 200 comprises a memory 202 including a plurality of cache lines for storing segments of data. Shown are cache lines 204a through 204n, where n is not limited to any particular value. A cache controller 206 accepts segments on line 208 to be written into cache lines 204. The cache controller 206 assigns a cache lock-time with a time duration to the segment. Each cache line 204 may cross-reference the data segment to an index (backup store address) and a tag. For simplicity, the data segment is also cross-referenced to the lock-time. However, the lock-time for a segment need not necessarily be stored in its corresponding cache line. The cache controller 206 stores the segment in memory 202 if a cache line 204 is available, and protects the segment stored in the cache line from replacement until the expiration of the lock-time. The cache controller 206 automatically makes the cache line 204 available for a replacement segment upon the expiration of the lock-time.

The cache controller 206 locates an available cache line in response by determining that the cache line is empty, or by determining that the cache line is available for a replacement segment. A cache line 204 is available for a replacement segment if the residing segment has an expired lock-time, or if the residing segment was assigned a “zero” duration (no) lock-time.

In one aspect, the system 200 accepts clock signals on line 209 from clock 210. Generally, the cache controller 206 assigns a lock-time equal to a selectable number of clock period intervals. The cache controller 206 decrements time from the assigned lock-times, in units of a clock period for example. The cache controller 206 protects the cache line from replacement if it is storing a segment with a lock-time greater than zero clock periods. However, a cache line is made available for a replacement segment if the cache line stores a segment with a lock-time equal to zero clock periods.

In one aspect, the cache controller accesses a list 212 with a plurality of lock-times having a corresponding plurality of time durations, selects a lock-time from the list, and assigns the selected lock-time to the segment. Shown in the list 212 are a “long” lock-time and a “short” lock-time. However, it should be understood that the system is not limited to any particular number of lock-time durations. In one variation, the cache controller has a configuration interface on line 214 to accept commands configuring the time duration for each of the lock-times on the list 212. In another aspect, the cache controller 206 accepts a communication on line identifying a segment of data as transient data. The cache controller selects a lock-time from the list 212 in response to the segment being identified as transient data.

For example, the cache controller 206 may accept a communication that identifies the input port (not shown) supplying the segment. The cache controller identifies the segment as transient data by cross-referencing input ports to transient data sources. The cross-referenced table is shown as port list 216. In another aspect, the cache controller assigns the lock-time in response to reading priority fields included in communications associated with the segment. This priority field may be in overhead accompanying the data segment, or be part of a separate communication.

If the cache controller 206 either reads or writes to a cache line with a previously assigned lock-time, a new lock-time can be assigned to the residing segment. Then, the cache controller protects the cache line from replacement until the expiration of the new lock-time.

Elements of the cache controller may be enabled in hardware, stored in memory as software commands executed by a processor, or be enabled as a combination of hardware and software elements.

### Functional Description

The time-based cache mechanism utilizes time (ageing) to enable allocation and replacement policies. If a segment is cached, it may be provided with a minimum time in which it will not be replaced. After this time the element is available to be replaced. This algorithm can be extended to provide multiple levels of priority within the cache array. Cacheable accesses with high priority status are provided with at least a minimum guaranteed cache time (if cache store is achieved). Cacheable accesses with low priority status may be immediately available for replacement by the replacement algorithm. The algorithm provides the equivalent of locking for high priority entries which are accessed within the expected time. However, entries not processed within this lock-time do not sustain protection. The cache processor is not required to manage the number of locked lines within the cache. The cache is only responsible for ageing each valid entry within the cache, based upon time elapsed since the lock-time was set (reset).

The time-based system is not restricted to any specific aging algorithm. For example, when a segment is loaded into the cache, the age value of the entry is set to the young_age value for high priority accesses or to the old_age value for low priority accesses. For the replacement decision, if the age of existing entry(s) is younger than old_age, then the entry is not available for replacement. However, if age of existing entry(s) is equal to or older than old_age, then the entry (data segment) is available for replacement. New requests to load the cache are subjected to the following decision tree: if an invalid segment is located, then load into empty location and reset age; else, if segment is found available for replacement, then replace and reset age; else, do not load into cache.

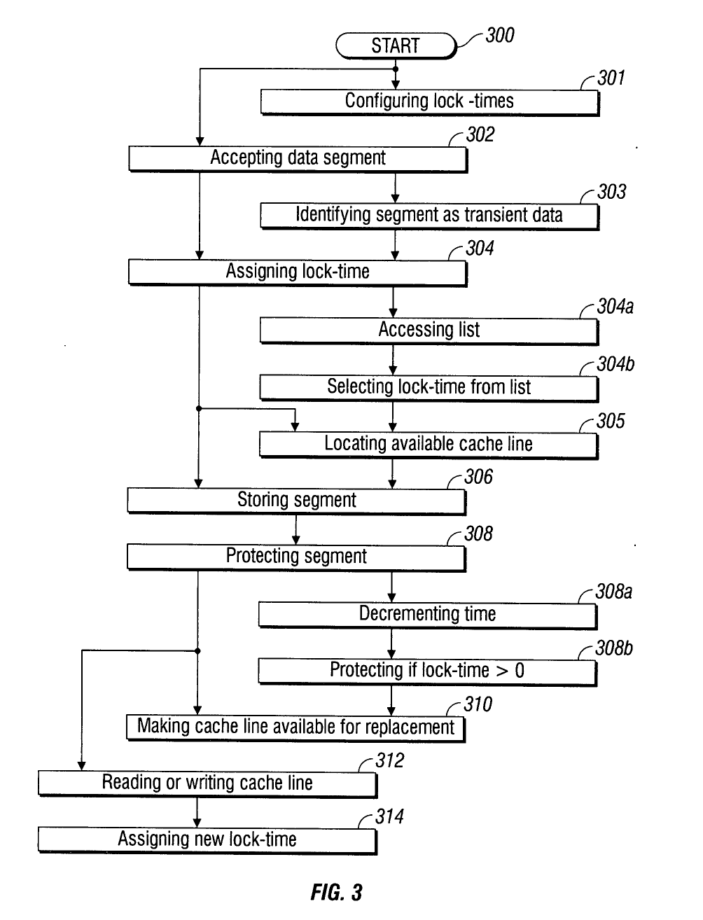

FIG. 3 is a flowchart illustrating a time-based method for controlling the management of cache memory. Although the method is depicted as a sequence of numbered steps for clarity, the numbering does not necessarily dictate the order of the steps. It should be understood that some of these steps may be skipped, performed in parallel, or performed without the requirement of maintaining a strict order of sequence. The method starts at Step 300.

Step 302 accepts a segment of data. Step 304 assigns a cache lock-time with a time duration to the segment. In one aspect, Step 305 locates an available cache line in response to either determining that the cache line is empty, or determining that the cache line is available for a replacement segment. If a cache line is available, Step 306 stores the segment. Step 308 protects the segment stored in the cache line from replacement until the expiration of the lock-time. Upon the expiration of the lock-time, Step 310 automatically makes the cache line available for a replacement segment.

In one aspect, assigning the lock-time to the segment in Step 304 includes assigning a lock-time equal to a plurality of clock period intervals. Then, protecting the segment stored in the cache line from replacement in Step 308 includes substeps. Step 308a decrements time from the assigned lock-times. Step 308b protects the cache line from replacement if storing a segment with a lock-time greater than zero clock periods. Step 310 makes the cache line available for a replacement segment if the cache line stores a segment with a lock-time equal to zero clock periods.

In another aspect, assigning the cache lock-time to the segment in Step 304 includes substeps. Step 304a accesses a list with a plurality of lock-times having a corresponding plurality of time durations. Step 304b selects a lock-time from the list. In a related aspect, prior to accepting the segment (Step 302), Step 301 configures the time duration for each lock-time in the list.

In a different aspect, Step 303 identifies the segment of data as transient data. Then Step 304 assigns a cache lock-time in response to identifying the segment as transient data. For example, Step 303 may identify the segment as transient data by cross-referencing input ports with transient data sources, and identifying the input port supplying the segment. Alternately, Step 303 may identify the segment as transient data by reading priority fields included in message associated with the segment.

Upon the performance of a process such as reading or writing the cache line, Step 312 assigns a new lock-time to the segment. Step 314 protects the cache line from replacement until the expiration of the new lock-time.

A time-based cache replacement system and method have been provided. Some explicit details and examples have been given to illustrate the invention. However, the invention is not limited to just these examples. Other variations and embodiments of the invention will occur to those skilled in the art.

We claim:

1. A time-based method for controlling the management of cache memory, the method comprising:
accepting a segment of data;
assigning a cache lock-time with a time duration to the segment;
if a cache line is available, storing the segment; and,
protecting the segment stored in the cache line from replacement until the expiration of the lock-time.

2. The method of claim 1 further comprising:
locating an available cache line in response to a process selected from the group consisting of determining that the cache line is empty and determining that the cache line is available for a replacement segment.

3. The method of claim 1 further comprising:
upon the expiration of the lock-time, automatically making the cache line available for a replacement segment.

4. The method of claim 3 wherein assigning the lock-time to the segment includes assigning a lock-time equal to a plurality of clock period intervals;
wherein protecting the segment stored in the cache line from replacement includes:
decrementing time from the assigned lock-times;
protecting the cache line from replacement, if storing a segment with a lock-time greater than zero clock periods; and,
wherein automatically making the cache line available for a replacement segment includes making the cache line available for a replacement segment, if the cache line stores a segment with a lock-time equal to zero clock periods.

5. The method of claim 1 wherein assigning the cache lock-time to the segment includes:
accessing a list with a plurality of lock-times having a corresponding plurality of time durations; and,
selecting a lock-time from the list.

6. The method of claim 5 further comprising:
identifying the segment of data as transient data; and,
wherein assigning the cache lock-time to the segment includes assigning a cache lock-time in response to identifying the segment as transient data.

7. The method of claim 6 wherein identifying the segment as transient data includes:
cross-referencing input ports with transient data sources; and,
identifying the input port supplying the segment.

8. The method of claim 6 wherein identifying the segment as transient data includes reading priority fields included in a message associated with the segment.

9. The method of claim 5 further comprising:
prior to accepting the segment, configuring the time duration for each lock-time in the list.

10. The method of claim 1 further comprising:
upon the performance of a process selected from a group consisting of reading and writing the cache line, assigning a new lock-time to the segment; and,
protecting the cache line from replacement until the expiration of the new lock-time.

11. A time-based cache memory management system, the system comprising:
a memory including a plurality of cache lines for storing segments of data; and,
a cache controller to accept a segment to be written into a cache line, assign a cache lock-time with a time duration to the segment, store the segment in memory if a cache line is available, and protect the segment stored in the cache line from replacement until the expiration of the lock-time.

12. The system of claim 11 wherein the cache controller locates an available cache line in response to a process selected from the group consisting of determining that the cache line is empty and determining that the cache line is available for a replacement segment.

13. The system of claim 11 wherein the cache controller automatically makes the cache line available for a replacement segment upon the expiration of the lock-time.

14. The system of claim 11 wherein the cache controller assigns a lock-time equal to a selectable number of clock period intervals; and,
wherein the cache controller decrements time from the assigned lock-times, protects the cache line from replacement if storing a segment with a lock-time greater than zero clock periods, and makes a cache line available for a replacement segment if the cache line stores a segment with a lock-time equal to zero clock periods.

15. The system of claim 11 wherein the cache controller accesses a list with a plurality of lock-times having a corresponding plurality of time durations, selects a lock-time from the list, and assigns the selected lock-time to the segment.

16. The system of claim 15 wherein the cache controller accepts a communication identifying the segment of data as transient data, and selects a lock-time from the list in response to the segment being identified as transient data.

17. The system of claim 15 wherein the cache controller accepts a communication identifying the input port supplying the segment, and identifies the segment as transient data by cross-referencing input ports to transient data sources.

18. The system of claim 15 wherein the cache controller assigns the lock-time in response to reading priority fields included in communications associated with the segment.

19. The method of claim 14 wherein the cache controller has a configuration interface to accept commands configuring the time duration for each of the lock-times on the list.

20. The system of claim 11 wherein the cache controller assigns a new lock-time to the segment upon the performance of a process selected from a group consisting of reading and writing the cache line, and protects the cache line from replacement until the expiration of the new lock-time.
